(19) United States
(12) Patent Application Publication
(10) Pub. No.: US 2006/0046759 A1
(43) Pub. Date: Mar. 2, 2006

(54) Mobile communication system using push to talk scheme for supplying location based service and method therefor

(75) Inventors: Sung-Jae Yoon, Gumi-si (KR); Ji-Hun Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/207,741

(22) Filed: Aug. 22, 2005

(30) Foreign Application Priority Data
Aug. 31, 2004 (KR) 2004-69172

(51) Int. Cl. H04B 7/00; H04Q 7/20

(52) U.S. Cl. 455/518; 455/507

(57) ABSTRACT

A mobile communication system using a push to talk (PTT) scheme for providing a location based service (LBS) is provided. The system comprises a positioning server for confirming requested location information and transmitting subscriber information corresponding to the requested location information in cooperation with a mobile switching center and a home location register, a PTT server for performing a general control for a PTT subscriber group and a real time management for the PTT subscriber group, managing PTT subscriber information and group lists setup by each subscriber, allocating predetermined location based groups to add the allocated location groups to the group lists which have been established by each subscriber, requesting subscriber information corresponding to the location information for the allocated location groups to the positioning server, receiving the subscriber information from the positioning server, and registering subscribers corresponding to the received subscriber information to the corresponding location groups, and a PTT module for performing PTT-call-related operation comprising a step of receiving the group list from the PTT server to display the received group list.

### PRIORITY

This application claims the benefit under 35 U.S.C. §119(a) of Korean Patent Application entitled “MOBILE COMMUNICATION SYSTEM USING PUSH TO TALK SCHEME FOR SUPPLYING LOCATION BASED SERVICE AND METHOD THEREFOR” filed in the Korean Industrial Property Office on Aug. 31, 2004 and assigned Serial No. 2004-69172, the entire contents of which are hereby incorporated by reference.

### BACKGROUND OF THE INVENTION

1. Field of the Invention

The present invention relates to a mobile communication system using a Push To Talk (PTT) scheme, and an operation method thereof. More particularly, the present invention relates to a mobile communication system of the PTT scheme for performing a location based service (LBS) and a method for providing the service thereof.

2. Description of the Related Art

The term “PTT” is referred to as “a basic call traffic scheme” used for a walkie-talkie or a Handheld Transceiver (HT). The PTT scheme allows a user to communicate with the other party by operating PTT buttons disposed on, for example, a walkie-talkie. Specifically, in an operation for communication based on the PTT scheme, the user simply presses the PTT button when talking to the other party, and releases the pressed PTT button when listening to the other party. Such a PTT scheme provides one-to-one or one-to-multiple party communication through which the users can simply and rapidly communicate with each other.

In recent years, conventional mobile communication systems have provided so called internet phone service of Voice over Internet Protocol (VoIP) scheme in which a predetermined IP has been assigned to each of the terminals of the system. Similar to the walkie-talkie or HT, such a VoIP scheme can also allow the mobile communication terminals to communicate with each other in the form of mobile communication PTT service which is capable of providing one-to-one or one-to-multiple communication.

Such a mobile communication PTT service can provide voice/data services through which multiple users or groups having mobile terminals can communicate simultaneously with each other. In order to start the mobile communication PTT service, the user presses a PTT button disposed in the mobile communication terminal capable of providing the PTT service so that the PTT mobile communication terminal may send a PTT service request to a mobile communication network related therewith. Then, the mobile communication network denies or accepts the requested service. In case of the acceptance, the network assigns the requested resources based on the determination criterions such as availability of resources, priority of the requesting user and the like. When the requested service has been accepted, the mobile communication network establishes connections among all the active users belonging to a certain user group. Consequently, the called mobile communication terminal outputs an alarm sound and display message for indicating the received PTT call request to the other called user who, then, recognizes the PTT call request to start a communication with the calling user. After setting up a voice traffic connection, the user who has requested a voice service can send the voice signal to the corresponding user who then can listen to the voice signal just sent.

In such a conventional mobile communication PTT service field, various functions for providing convenience and efficiency have been developed and adopted to meet users' various demands.

In a conventional mobile communication system, a mobile communication terminal generally performs not only a voice call traffic function by exchanging radio signals with a base station, but also a variety of additional functions such as short message service (SMS) and data service. Furthermore, the mobile communication terminal receives various location based services (LBSs) by using location information of the mobile communication terminal based on a radio determination technology. Such a radio determination technology comprises, for example, a cell-ID-based radio determination scheme by using the location information of the mobile terminals of a base station, a network-based radio determination scheme which allows the location of the mobile terminal to be tracked based on pilot signals used in the mobile communication terminal, and a global positioning system (GPS)-based radio determination scheme in which GPS chipsets are mounted on the mobile communication terminal.

The cell-ID-based radio determination scheme uses relationships of angle of arrival (AOA) or time of arrival (TOA) for radio waves to measure a distance between a mobile communication terminal and a base station. In the network-based radio determination scheme, the base station, which has already determined an exactly fixed location of itself, measures a distance between mobile communication terminals to measure two dimensional location information. The GPS-based radio determination scheme uses GPS satellites to analyze satellite signals and measure three dimensional location information of the mobile communication terminal based on the analyzed signals, regardless of time.

If a mobile communication terminal is connected to a base station and a controller of the base station via a mobile communication network, the information of the mobile communication terminal is registered in a home location register unit of a switching center. The switching center uses the cell-ID-based radio determination scheme, the network-based radio determination scheme and/or the GPS-based radio determination scheme and the like to measure location information of related mobile communication terminals. The resultant measured location information is provided to, for example, a server for providing the location based service so that the information may be used for various services.

### SUMMARY OF THE INVENTION

Accordingly, the present invention has been made to solve the above-mentioned problems occurring in the prior art, and an object of the present invention is to provide a method for providing a location based service (LBS) in a mobile communication system by using the Push To Talk (PTT) scheme.

Another object of the present invention is to provide a method for providing an advertisement service based on the location based service (LBS) in a mobile communication system by using Push To Talk (PTT).

In order to accomplish this object, according to one aspect of the present invention, a mobile communication system using the PTT scheme for providing a location based service (LBS) is provided. The system comprises a positioning server for confirming requested location information and transmitting subscriber information corresponding to the requested location information in cooperation with a mobile switching center and a home location register, a PTT server for performing a general control for a PTT subscriber group and a real-time management for the PTT subscriber group, managing PTT subscriber information and group lists established by each subscriber, allocating predetermined location (based) groups to add the allocated location groups to the group lists which have been established by each subscriber, requesting subscriber information corresponding to the location information for the allocated location groups to the positioning server, receiving the subscriber information from the positioning server, and registering subscribers corresponding to the received subscriber information to the corresponding location groups, and a PTT module for performing PTT-call-related operation comprising a step of receiving the group list from the PTT server to display the received group list.

In order to accomplish this object, according to another aspect of the present invention, a method for performing a location based service in a communication system by using the PTT scheme is provided. The method comprises the steps of allocating, by a PTT server, predetermined location (based) groups to add the allocated location groups to the group lists which have been established by each subscriber, requesting, subscriber information located in a selected location group to the positioning server to confirm the subscribers, when each subscriber mobile communication terminal just selects one of the location groups and sends a transmission request of Instant Messaging (IM)/Push To Data (PTD) data, and transmitting the IM/PTD data to the mobile communication terminal of the confirmed subscribers located in the selected location group.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic block diagram illustrating a mobile communication system using a Push To Talk (PTT) scheme which provides a location based service (LBS) according to an exemplary embodiment of the present invention;

FIG. 2A is a schematic block diagram illustrating a PTT mobile communication terminal according to an exemplary embodiment of the present invention;

FIG. 2B a diagram illustrating a PTT mobile communication terminal according to an exemplary embodiment of the present invention;

FIG. 3 is a flow chart illustrating a general PTT call traffic connection in the mobile communication system of FIG. 1.; and

FIG. 4 is a flow chart illustrating a PTT call traffic connection in the mobile communication system for providing a LBS according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

Hereinafter, exemplary embodiments of the present invention will be described with reference to the accompanying drawings. The specific embodiments such as concrete constituent elements found in the following description are merely exemplary. Therefore, it will be understood by those skilled in the art that various changes in form and details may be made therein without departing from the spirit and scope of the invention.

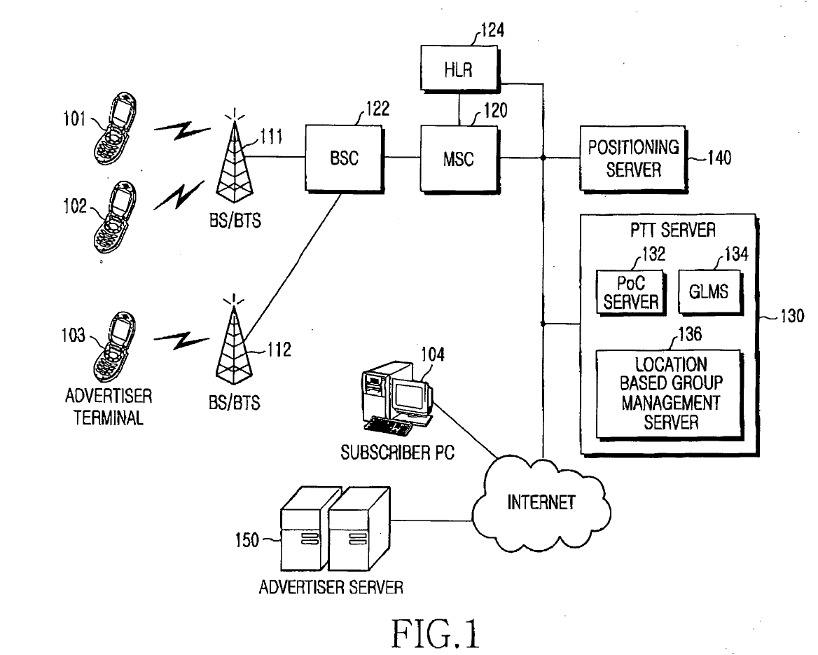

FIG. 1 is a schematic block diagram illustrating a mobile communication system using a Push To Talk (PTT) scheme according to an exemplary embodiment of the present invention. Referring to FIG. 1, the mobile communication system using the PTT scheme comprises generally a plurality of base station transceiver systems (BTSs, or BSs) 111 and 112 which communicate with a plurality of mobile communication terminals 101, 102 and 103 located in the service coverage area of the BTSs to provide the mobile communication services. The plurality of base station transceiver systems (BTSs, or BSs) 111 and 112 are connected to a mobile switching center (MSC) 120 via a base station controller (BSC). Also, the MSC (120) again is connected to a PTT server 130 via a data network.

The mobile communication terminals 101, 102 and 103 send a call setup request message for voice or data services to the BTSs 111 and 112, transmit voice or data messages input by users to the BTSs 111 and 112 via wireless network sections, and display thereon voice or data messages transmitted from the BTSs 111 and 112 for users' view. The BTSs 111 and 112 receives the call setup request message for a voice or data service from the mobile communication terminals 101, 102 and 103, and request the call setup to the MSC 120 via the BSC 120. Also, the BTSs 111 and 112 receive a voice or data message from the MSC 120 and transmit the received voice or data message to the mobile communication terminals 101, 102 and 103. The BSC 122 controls the plurality of BTSs 111 and 112 to control the call setups for data transmissions between the MSC 120 and the BTSs 111 and 112. When receiving the call setup request message from the BTSs 111 and 112, the MSC 120 inquires location information of a called mobile communication terminal from a home location register (HLR) to send the call setup request message to a counter station which covers the called mobile communication terminal, and to transmit the received voice or data message of the BTSs 111 and 112 to the counter station. Meanwhile, a positioning server 140 provides a variety of location information in cooperation with the MSC 120 and the HLR 124 via a data network.

Hereinafter, a description will be made about the operation of the location based service using the AOA-based radio determination scheme or the network-based radio determination scheme. The BSC 122 controls the base station, such as BTSs, and transmits its ID information having its location information to the MSC 120 one time per a predetermined period, for example, every 2 hours. The MSC 120 updates last base station information based on the base station received from the BSC 122, and sends the updated base station information to the positioning server 140. Accordingly, the positioning server 140 also updates the base station information. Therefore, the positioning server can confirm the base station located in a position where a corresponding location based group, which will be described later, are located, according to an exemplary embodiment of the present invention. In this case, when receiving a location confirmation request message for a desired mobile communication terminal, the positioning server 140 requests the current location information of the desired mobile communication terminal to the HLR 124. Then, the HLR 124 transmits, to the positioning server 140, information about a corresponding MSC, such as corresponding MSC information, to which the desired mobile communication terminal belongs. Accordingly, the positioning server 140 sends the request message for requesting the location information of the desired mobile terminal to the corresponding MSC to which the desired terminal belongs as mentioned above. In response to such a request message, the corresponding MSC transmits the request message to a corresponding BSC which then transmits the target location information of the desired mobile communication terminal to the MSC. By the way, the target location information of the desired mobile communication terminal is measured in base station(s) to which the desired terminal belongs. The target location information which has been transmitted the corresponding MSC is again transferred to the positioning server 140 which, accordingly, can be aware of the location position of the desired mobile communication terminal based on the received location information.

The PTT server 130 performs real-time management operation for PTT user groups comprising general controlling for PTT user groups, mediating and holding of PTT communication requests, distributing subscriber registration lists and call setups/separations of needed systems and network resources. Such a PTT server 130 comprises a PTT over Cellular (PoC) server 132 for performing a communication function for the PTT service in the mobile communication network, and a Group and List Management Server (GLMS) 134 for managing PTT subscribers' information and subscriber group list (called a “buddy list”).

According to an exemplary embodiment of the present invention, such a PTT server 130 comprises a location based group management server 136 which allocates previously established location groups, determines if a current subscriber belongs to a corresponding location group in cooperation with the positioning server 140, and automatically registering the current subscriber to the corresponding location based group in accordance with the determination. For example, the location based management server 136 of the PTT server 130 may previously and variously classify (allocate) the location based groups, such as regional groups such as city and county, geographical groups such as rivers, mountains and coast, and expressway groups and the like. When receiving a confirmation request message from a subscriber that has been registered in each location group, the PTT server directs the positioning server 140 to search and confirm the corresponding subscribers located in the corresponding location group and automatically register the confirmed subscribers to the corresponding location group. All the groups are preferably classified and allocated by the location based management server 136 and added to group lists which are established privately by each subscriber based on a buddy list of the subscriber such that all the subscribers may share the group lists. Meanwhile, the location based group management server 136 is designated as a separate element differentiated with PoC server 132 and GLMS 134, as shown in FIG. 1. Such a separate element, however, is intended only for convenience and clarity of the description. That is, the function of the location based group management server 136 may be performed by the GLMS 134, for example.

Each of the mobile communication terminals 101, 102 and 103 comprises a PTT module for performing PTT-related operations such as a PTT call request transferred to the PTT server 130 to wirelessly send the PTT call request in the form of previously and properly established format to the BTSs 111 and 112 when operating the PTT call traffic. The MSC 120 receives the PTT call request from the BTSs 111 and 112 and provides the received PTT call request to the PTT server 130. The MSC 120 has an Inter Working Function (IWF) for processing certain data packets comprising such a PTT call request with the PTT server 130.

The users can connect their mobile communication terminals 101, 102 and 103 to the PTT server 130 to perform modification operations such as newly establishing, changing or deleting the group list information and individual information which has been previously established by the users. Alternatively, the user can connect their personal computer 104 to the PTT server 130 via the Internet to also modify the group list information and the individual information which has been previously established by the user. Further, according to an exemplary embodiment of the present invention, FIG. 1 shows an advertiser terminal 103 connected to the mobile communication network and an advertiser server 150 connected to the PTT server 130 via the Internet in order to perform an advertisement service based on the location based groups. The structures of the advertiser terminal 103 or the advertiser 150 may be the same as those of the typical mobile communication terminals 101 and 102 and the subscriber's PC except that the advertiser terminal 103 or the advertiser server 150 stores therein special images/dynamic videos/messages consisting of advertisements and has subscribers who are advertisers.

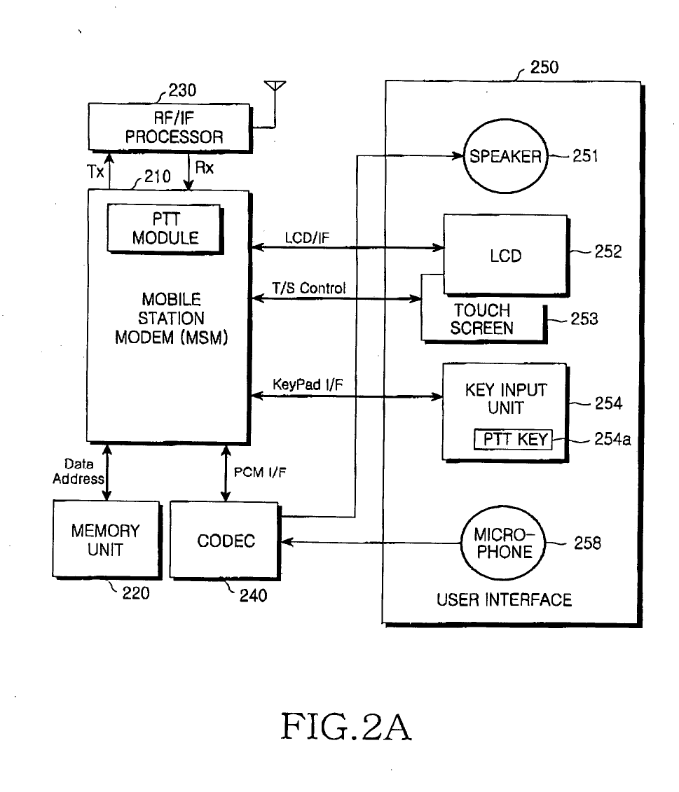

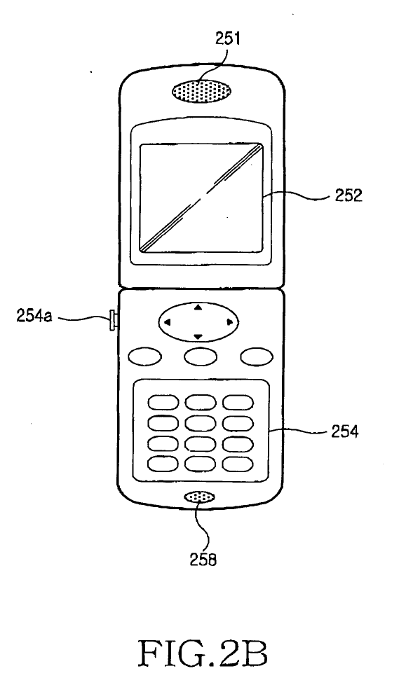

FIG. 2A is a schematic block diagram illustrating a PTT mobile communication terminal according to an exemplary embodiment of the present invention, and FIG. 2B illustrates an exterior structure of a PTT mobile communication terminal according to an exemplary embodiment of the present invention. Referring to FIGS. 2A and 2B, the mobile communication terminal according to an embodiment of the present invention is capable of performing an interface operation with the user. The mobile communication terminal comprises a user interface 250, a radio frequency/intermediate frequency (RF/IF) processor 230 for processing radio signals, a memory unit 220 preferably having read only memory (ROM) (not shown) and random access memory (RAM) (not shown) for storing various operation programs and operation-related data, a voice signal processor (CODEC) 240 for processing voice signals and a mobile station modem (MSM) 210 for serving as a modem as well as a central processing unit for controlling the entire portion of a mobile communication terminal. The user interface 250 has a speaker 251, a display unit such as liquid crystal display (LCD) 252, a key input unit 254 and a microphone 258.

Hereinafter, the operation of each function unit of the mobile communication terminal applied to an exemplary embodiment of the present invention will be described. First, in the user interface 250, the microphone 258 converts the user's voice into an electrical signal to send the electrical signal to the voice signal processor (CODEC) 240. In contrast, the speaker 251 receives the electrical signal from the voice signal processor 240 and generates an audible sound based on the received electrical signals. The key input unit 254 of the user interface 250 comprises a plurality of numeric/character keys for inputting numbers and characters, a plurality of function keys for performing the mobile communication functions, and dedicated PTT keys 254a for performing the PTT functions. Such a key input unit 254 transfers key input data to the mobile station modem 210 when the user inputs the related certain data or information through the keys of the unit. Although the dedicated PTT keys 254a are disposed in the separate form from the other keys on the key input unit as shown in FIG. 2a, the PTT keys may be implemented by using a part of the known or conventional keys. The display unit 252, which is typically a LCD display, comprises generally an LCD controller and a memory for storing image data and LCD display elements. The display unit 252 displays characters or number information such as a current condition of the mobile communication terminal or background images related therewith. The display unit 252 may have a touch screen 253 for the LCD.

The RF/IF processor 230 comprises a RF transmitter (not shown) for up-converting frequencies of the signals to be transmitted and amplifying the signals, and a RF receiver (not shown) for low-noise amplifying received signals and down-converting the frequencies of the received signals. The RF/IF processor 230 receives modulated signals from the mobile station modem 210, converts the modulated signals into intermediate frequencies (IF). Also, the RF/IF processor 230 converts the intermediate frequencies into radio frequencies (RF) to be output to the BTSs via an antenna. Furthermore, the RF/IF receives the radio signals from the BTSs via an antenna so that the received radio signals are converted sequentially into the intermediate frequencies and the baseband to be provided to the mobile station modem 210.

The voice signal processor 240 which is typically formed of audio CODEC receives analog voice signals from the microphone 258 to convert the received analog voice signals into digital signals (PCM) which are transmitted to the mobile station modem 210. Also, the voice signal processor 240 receives digital signals (PCM) of an other party's voice from the mobile station modem 210 to convert the received digital signals to the analog signals to be output to the speaker 251. Although the voice signal processor 240 is designed in the separate form as shown in FIG. 2a, the processor 240 may be embedded integrally in the mobile station modem so that the processor and the modem may be combined together in the form of one chip.

The mobile station modem 210 can perform various functions of the mobile communication terminal in accordance with the key data input through the key input unit 254, while the various information such as current states and user menu may be displayed on the display unit based on the performing of the functions. Especially, in case of processing the voice signals for phone traffic, the mobile station modem 210 receives the PCM voice signals from the voice signal processor 240, and converts and modulates the received PCM voice signals by channel coding and interleaving to provide the converted and modulated signals to the RF/IF processor 230. Further, the mobile station modem 210 receives the voice signals provided from the RF/IF processor 230 and processes the received voice signals through demodulating, equalizing, channel decoding and deinterleaving to generate the resultant PCM voice signals which are then sent to the voice signal processor 240. Furthermore, the mobile station modem 210 has a PTT module for performing the PTT services, especially an advertisement-transmission operation for the subscribers of the location based groups, based on an exemplary embodiment of the present invention.

In operation of the mobile communication terminal shown in FIGS. 2A and 2B, if the user performs a dialing operation and a setting operation for a calling mode through the key input unit 254, then the mobile station modem 210 monitors those operations and processes the input dialing information to then convert the input dialing information into corresponding radio signals through the RF/IF processor 230 to be output. Next, response signals are received from the other party's terminal via the RF/IF processor 230 in the mobile station modem 210 so that the received response signals may be output to the speaker 251 via the voice signal processor 240 to consequently form a voice traffic path for communication. In case of the called mode, the mobile station modem 210 monitors just the called mode through the RF/IF processor 230, and directs the voice signal processor 240 to generate corresponding ring signals. Next, similar to the calling mode, when the other party sends response signals, the mobile station modem 210 monitors that response signals which may be output to the speaker 251 via the voice signal processor 240 to consequently form a voice traffic path for communication. As mentioned above, only the exemplary voice communication was described for both the calling and the called modes according to an exemplary embodiment of the present invention. However, alternatively, data communication functions for packet data and image data and the PTT communication operation based on PTT key inputs also can be applied to an exemplary embodiment of the present invention.

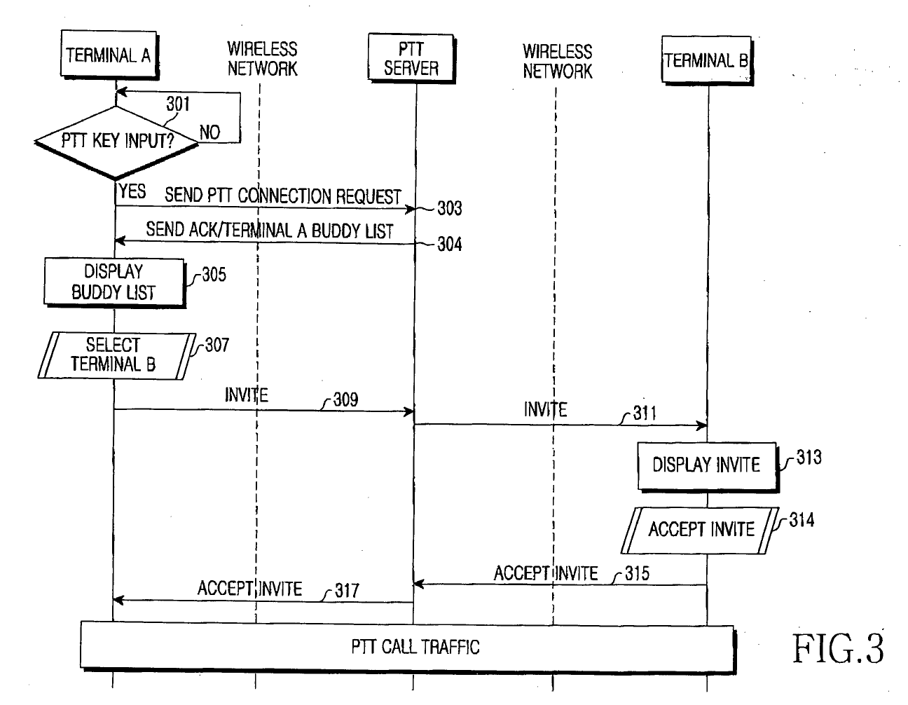

FIG. 3 is a flow chart illustrating an operation process of a general PTT call traffic connection in the mobile communication system of FIG. 1. Referring to FIG. 3, if a user wants the PTT communication and inputs the PTT key disposed on a mobile communication terminal (terminal A in FIG. 3) or operates PTT call functions by a menu setting operation, then in step 301 the mobile station modem confirms the PTT key input or the operation of the PTT call functions to drive a PTT application. Next, in step 303, the mobile station modem sends a PTT connection request message to the PTT server via the wireless network. If the PTT server confirms the corresponding user who has previously sent the PTT connection request message through the GLMS server, then in step 304, the PTT server acknowledges the PTT connection request of the corresponding user and sends a buddy list which is subscriber information of the terminal A PTT call traffic group to the corresponding user, such as sending ACK/terminal A buddy list. Accordingly, the mobile station modem of the terminal A receives such a buddy list so that the display unit may properly display the buddy list in step 305. Referring to the displayed buddy list, the user of the terminal A can operate predetermined direction keys to select the other party who the user wants to communicate with through the PTT scheme. Specifically, in step 307, the mobile communication terminal (terminal A) inputs the selected the other party or the selected subscriber (in case of FIG. 3, terminal B) by the user's operation. Next, in step 309, the mobile communication terminal (terminal A) sends a PTT call request message (referred to as “INVITE”) for the selected subscriber (terminal B) to the PTT server via the wireless network. Such a PTT call request message (INVITE) comprises, for example, ID information of the calling or called party.

Hereinafter, a description will be made in greater detail about the step that the mobile communication terminal (Terminal A) sends the PTT call request (INVITE) to the PTT server. First, the mobile communication terminal (terminal A) sends the PTT call request message (INVITE) in the form of a Short Data 10. Burst (SDB) to the base station to which the terminal A is connected. Then, the mobile communication terminal (terminal A) negotiates (nego) with the base station for service option (SO_PTT) to provide the PTT service, and performs Traffic Channel (TCH) setup. The term “nego” refers to a process for preparing for higher network sessions which are ranged from physical layers comprising PPP session to application layers.

After this, the base station sends the PTT call request message (INVITE) to the PTT server which then confirms the ID of the called party based on the received message (INVITE). Next, in step 311, the PTT server sends the PTT call request message (INVITE) to the called mobile communication terminal (terminal B). Then, the called mobile communication terminal (terminal B) receives the PTT call request message (INVITE), and in step 313, informs the reception of the PTT call request message (INVITE) to the corresponding user by sounding the predetermined alarm and displaying the predetermined alarm message.

Step 311 and step 313 will be described in greater detail as follow. The PTT server sends the PTT call request message (INVITE) to a corresponding base station which provides the services to the called mobile communication terminal (terminal B). The corresponding base station for the called mobile communication terminal sends periodically paging signal such as General Page (GB) to the called mobile communication terminal (terminal B) which then sends the corresponding response signal such as Page Response (PR) for the GP to the corresponding base station. During such a paging process, the base station sends the PTT call request message (INVITE) in the form of SDB to the called mobile communication terminal (terminal B). Then, the called mobile communication terminal informs the reception of the PTT call request message (INVITE) to the called party. At the same time, the called mobile communication terminal (terminal B) sends acknowledgement of the reception of the PTT call request message (INVITE) to the base station.

In contrast, if the called user has recognized the reception of the PTT call request message (INVITE) in step 313, the called party can allow or accept the corresponding PTT call request by operating the predetermined keys such that, in step 314, the called mobile communication terminal (terminal B) can receive the key inputs for accepting the PTT call request, and in step 315 can send the PTT call request acceptance message to the PTT server via the wireless network. In step 317, the PTT server informs just the PTT call request acceptance to the calling mobile communication terminal (terminal A) to allow calling through the PTT call traffic.

Step 315 and step 317 will be described in greater detail as following. When sending the PTT call request acceptance, the called mobile communication terminal (Terminal B) sends the PTT call request acceptance message (so called “200 OK”) in the form of SDB to a corresponding base station. Then, the called mobile communication terminal (terminal B) negotiates (nego) with the corresponding base station for service option (SO_PTT) to provide the PTT service, and performs Traffic Channel (TCH) setup. The PTT call request acceptance message such as 200 OK originated in the called mobile communication terminal (terminal B) is transferred finally to the calling mobile communication terminal (terminal A) via the base station of the called party, the PTT server and the base station of the calling party. The calling mobile communication terminal (terminal A) receives the PTT call request acceptance message to complete the traffic channel setup. Also, the calling mobile communication terminal informs the PTT call request acceptance to its user by displaying the alarm message through the display unit.

After this, in the PTT call traffic between the calling and the called mobile communication terminals, a specific terminal (for example, terminal A) sends a speaking right request message referred to as “Session Initiation Protocol (SIP) Ack” to the PTT server. Then, the PTT server controls the speaking permission requests between the terminals to grant the speaking permission to a predetermined mobile communication terminal. The mobile communication terminal which has obtained the speaking right transmits, in real-time, the talk burst to the PTT server through a Real Time Protocol (RTP). The PTT server performs firstly buffering of the talk burst to transmit the buffered talk burst to the called mobile communication terminal through the RTP.

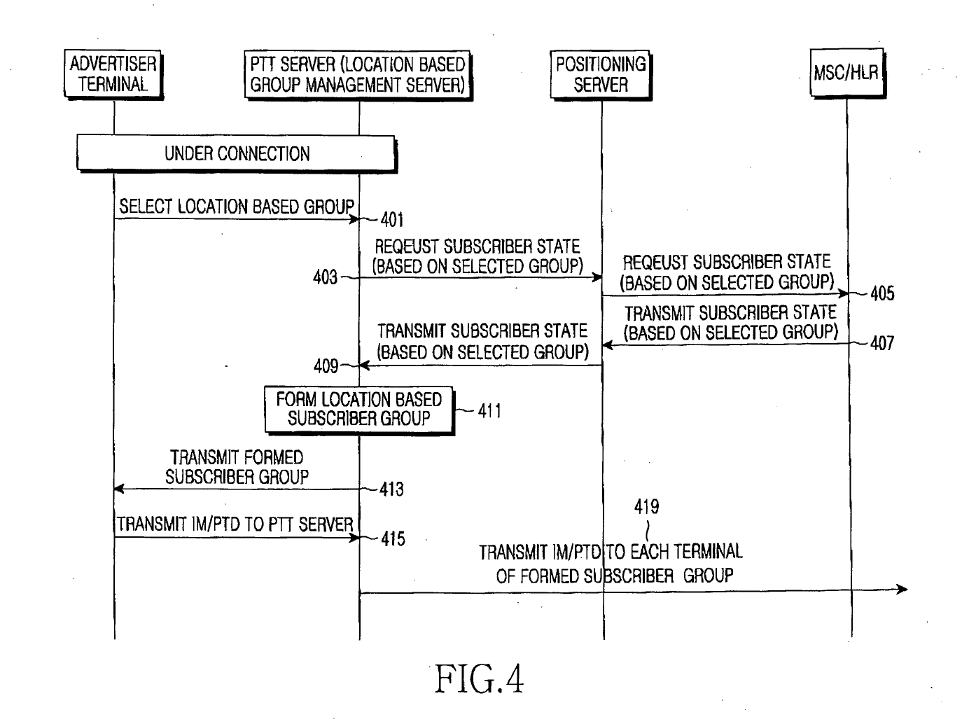

FIG. 4 is a flow chart illustrating an operation process of PTT call traffic for performing the location based service in the mobile communication system of FIG. 1 according to an exemplary embodiment of the present invention. Referring to FIG. 4, when the advertiser terminal, such as the mobile communication terminal, is being connected to the PTT server, the advertiser, such as corresponding subscriber, may confirm a buddy list displayed on the terminal and select one of the previously established location based groups by operating or manipulating directional keys formed on the terminal in order to determine or search an advertised area. For example, if the advertiser who is a store owner wants to advertise her/his own store near to an area where the store is located, the advertiser may establish one predetermined regional group which corresponds to the area where the store is located, from the regional groups, such as city and county, in all the location based groups which are added to the buddy list as the shared groups.

If the advertiser selects one predetermined group in her/his terminal, then in step 401, the selection information of the group is transmitted to the PTT server such as the location based management server. Next, in step 403, the PTT server requests state information of the subscribers currently established in the selected location based group to the positioning server. Then, in step 405, the positioning server, also, requests the state information of the current subscribers to the MSC. Next, in step 407, the MSC confirms the subscriber of the corresponding area to transmit the requested state information of the current subscribers to the positioning server. At this time, the positioning server may request, to a base station, the information of the mobile communication terminals which the base station is now providing the service, or may determine the current locations of all the subscriber's mobile communication terminals to find out the mobile communication terminals located in the selected location based group. The positioning server receives the state information of the subscribers belonged to the selected location based group as mentioned above, and in step 409, transmits the received state information to the PTT server. Next, in step 411, the PTT server establishes the subscribers based on the received state information of the subscribers to form a subscriber group. Next, in step 413, the information of the formed subscriber group is transmitted to the advertiser terminal. Then, the advertiser can monitor the subscriber information of the selected location based group displayed on her/his terminal to transmit the previously stored images/dynamic video file or character messages for the advertisement in the form of instant messaging (IM)/Push To Data (PTD) data. Specifically, in accordance with the advertiser's operation mentioned above, in step 415, the advertiser terminal transmits the IM/PTD data to each of the subscriber group formed by the PTT sever. Next, in step 419, the transmitted IM/PTD data reach each terminal of the subscribers established on the selected location based group. Then, the each terminal sounds an alarm and displays a predetermined message for indicating the reception of the IM/PTD data such that the advertiser's store can be advertised to the subscribers in the area where the store is located. Therefore, if a subscriber which has seen the advertisement about the store may transmit a PTT call request message (INVITE) to the advertiser, then the PTT call traffic of FIG. 3 can be established between the initiating (calling) subscriber's terminal and the called advertiser terminal so that the calling subscriber may directly inquire of the advertiser about the advertisement in greater detail.

As mentioned above, the mobile communication system and the service operation method using the PTT scheme can be implemented to provide the location based service according to an exemplary embodiment of the present invention. While the invention has been shown and described with reference to certain exemplary embodiments thereof, it will be understood by those skilled in the art that various changes in form and details may be made therein without departing from the present invention. Specifically, in the above exemplary embodiment, if the advertiser selects a predetermined location based group, the advertiser terminal displays the state information of the subscribers belonged to the selected location based group in the above exemplary embodiment. Besides this, however, the advertiser terminal may have a selection item for selecting the predetermined location based group with which the advertisement IM/PTD data can be directly transmitted without display of the state information of the subscribers thereon. In this modified case, the PTT server receives the advertisement IM/PTD data from the advertiser terminal, and determines and confirms the subscribers belonged to the selected location based group to immediately transmit the received advertisement IM/PTD data to each of the confirmed subscribers. Also, in the above exemplary embodiment, the advertiser terminal selects the predetermined location based group and then transmit the advertisement IM/PTD data to the selected location based group. However, the advertiser terminal may establish a predetermined time and the advertisement IM/PTD data to be transmitted, and then automatically connects to the PTT server when it is just setup for the proper time to perform the advertisement operation of FIG. 4. Further, in the above exemplary embodiment, the location based groups are classified into the regional groups, the geographical groups and the express way groups by way of example. Besides this, however, the location based groups may comprises sport stadium or ground groups or auditorium groups and the like, which may be used for advertisement during public guide information broadcasting, game relay broadcasting or public performance relay broadcasting. Furthermore, in the above exemplary embodiment, the advertiser selects a predetermined location based group and provides her/his advertisement to the subscribers belonged to the selected location based groups. However, the advertiser may select a predetermined location based group and send PTT call request message (INVITE) to all the subscriber currently established or any subscribers in the selected location based group to perform the PTT call traffic with the subscribers. In this modified exemplary embodiment of the present invention, for example, when a certain subscriber drives in a expressway, the certain subscriber may select the location based group of a expressway section in order to ask a current environment or situation of the expressway section to any one of the subscribers established currently in the location based group of the expressway section.

As mentioned above, various changes in forms and details may be made according to the present invention. Therefore, the scope of the present invention should be defined based on not the above exemplary embodiments but the appended claims.

As mentioned above, the location based service in the mobile communication system by using the PTT scheme can be implemented according to the present invention, wherein the PTT call traffic groups can be automatically classified and allocated based on the predetermined location areas, a certain subscriber or an advertiser may connect to the subscribers currently located to the selected or desired group by the PTT call traffic to perform various location based services such as advertising.

What is claimed is:

1. A mobile communication system using a push to talk (PTT) scheme for providing a location based service (LBS), the system comprising:
a positioning server for confirming requested location information and transmitting subscriber information corresponding to the requested location information in cooperation with a mobile switching center and a home location register;
a PTT server for performing a general control for a PTT subscriber group and real time management for the PTT subscriber group, managing PTT subscriber information and group lists established by each subscriber, allocating predetermined location (based) groups to add the allocated location groups to the group lists which have been established by each subscriber, requesting subscriber information corresponding to the location information for the allocated location groups to the positioning server, receiving the subscriber information from the positioning server, and registering subscribers corresponding to the received subscriber information to the corresponding location groups; and
a PTT module for performing PTT-call-related operation comprising receiving the group list from the PTT server to display the received group list.

2. The system as claimed in claim 1, wherein the PTT server comprises:
a PTT over Cellular (PoC) server for performing a communication function of a PTT service in a mobile communication network,
a group and list management server (GLMS) for managing the PTT subscriber information and the group list for each subscriber, and
a location based group management server for allocating predetermined location groups to add the allocated location groups to the group lists which have been established by each subscriber, requesting subscriber information corresponding to the location information for the allocated location groups to the positioning server, receiving the subscriber information from the positioning server, and registering subscribers corresponding to the received subscriber information to the corresponding location groups.

3. A method for performing a location based service in a communication system by using a push to talk (PTT) scheme, the method comprising the steps of:
allocating, by a PTT server, predetermined location (based) groups to add the allocated location groups to the group lists which have been established by each subscriber,
requesting subscriber information located in the allocated location groups to the positioning server to confirm the subscribers; and
registering the confirmed subscribers located in a selected location group to the selected regional group.

4. The method as claimed in claim 3, wherein when each subscriber mobile communication terminal selects one of the location groups, the step of requesting the subscriber information is performed.

5. The method as claimed in claim 3, wherein the location groups includes regional groups comprising city/county and smaller administrational (district) areas, geographical groups comprising rivers, mountains and coast, and expressway groups comprising predetermined sections.

6. The method as claimed in claim 4, wherein the location groups includes regional groups comprising city/county and smaller administrational (district) areas, geographical groups comprising rivers, mountains and coast, and expressway groups comprising predetermined sections.

7. A method for performing a location based service in a communication system by using a push to talk (PTT) scheme, the method comprising the steps of:
allocating, by a PTT server, predetermined location (based) groups to add the allocated location groups to the group lists which have been established by each subscriber;
requesting subscriber information located in a selected location group to the positioning server to confirm the subscribers, when each subscriber mobile communication terminal just selects one of the location groups and requests a transmission of Instant Messaging (IM)/Push To Data (PTD) data; and
transmitting the IM/PTD data to the mobile communication terminal of the confirmed subscribers located in the selected location group.

8. The method as claimed in claim 7, wherein the selection of the location group and the transmission request of the IM/PTD data are transmitted in a predetermined period in each subscriber terminal.

9. The method as claimed in claim 8, wherein the selection of the location group and the transmission request of the IM/PTD data are transmitted in a predetermined period in each subscriber terminal.

10. The method as claimed in claim 7, wherein the location groups includes regional groups comprising city/county and smaller administrational (district) areas, geographical groups comprising rivers, mountains and coast, and expressway groups including predetermined sections.

11. The method as claimed in claim 8, wherein the location groups includes regional groups comprising city/county and smaller administrational (district) areas, geographical groups comprising rivers, mountains and coast, and expressway groups including predetermined sections.

12. The method as claimed in claim 9, wherein the location groups includes regional groups comprising city/county and smaller administrational (district) areas, geographical groups comprising rivers, mountains and coast, and expressway groups including predetermined sections.
